(19) United States
(12) Patent Application Publication
(10) Pub. No.: US 2012/0054258 A1
(43) Pub. Date: Mar. 1, 2012

(54) System and Method for Transmitting a Control Channel

(75) Inventors: Zhongfeng Li, Shanghai (CN); Philippe Sartori, Algonquin, IL (US); Anthony C.K. Soong, Plano, TX (US); Rongting Gu, Shanghai (CN)

(73) Assignee: FutureWei Technologies, Inc., Plano, TX (US)

(21) Appl. No.: 13/219,426

(22) Filed: Aug. 26, 2011

Related U.S. Application Data
(60) Provisional application No. 61/377,807, filed on Aug. 27, 2010.

(51) Int. Cl. G06F 15/16

(52) U.S. Cl. 709/201

(57) ABSTRACT

A system and method for transmitting a control channel are provided. A method for communications controller operations includes generating a first control message from a first group of information, where the first control message occupies two transmission resources, and where a physical transmission resource includes a pair of distributed transmission resources. The method also includes mapping a first transmission resource to a first distributed transmission resource having a first index, and mapping a second transmission resource to a second distributed transmission resource having a second index, where the first index and the second index differ by a value equal to a difference in indices of distributed transmission resources in the pair of distributed transmission resources, and where the difference in indices is greater than or equal to two. The method further includes transmitting a first physical transmission resource associated with the first distributed transmission resource and a second physical transmission resource associated with the second distributed transmission resource.

This application claims the benefit of U.S. Provisional Application No. 61/377,807 filed on Aug. 27, 2010, entitled “Method and System for Blind Transmission/Decoding,” which application is hereby incorporated herein by reference.

### TECHNICAL FIELD

The present invention relates generally to digital communications, and more particularly to a system and method for transmitting a control channel.

### BACKGROUND

A relay node (RN), or simply relay, is considered as a tool to improve, e.g., the coverage of high data rates, group mobility, temporary network deployment, the cell-edge throughput and/or to provide coverage in new areas. The RN is wirelessly connected to a wireless communications network via a donor cell (also referred to as a donor enhanced Node B (donor eNB or D-eNB)).

The donor eNB provides some of its own network resources for use by the RN. The network resources assigned to the RN may be controlled by the RN, as if the provided network resources were its own network resources.

Relaying is currently being discussed within the Third Generation Partnership Project (3GPP) Long Term Evolution (LTE) Radio Access Network One (RAN1) subgroup for standardization. In relaying, a Relay Physical Downlink Control Channel (R-PDCCH) may be used to signal control information from the D-eNB to the RN. However, in the 3GPP LTE technical standards, the R-PDCCH is not located within the control area of a subframe. Instead, the R-PDCCH is located within the data area of a subframe. Therefore, a widely discussed issue involves the efficient utilization of the resources in the data area of the subframe.

### SUMMARY OF THE INVENTION

These and other problems are generally solved or circumvented, and technical advantages are generally achieved, by example embodiments of the present invention which provides a system and method for a system and method for transmitting a control channel.

In accordance with an example embodiment of the present invention, a method for communications controller operations is provided. The method includes generating a first control message from a first group of information, where the first control message occupies two transmission resources, and where a physical transmission resource includes a pair of distributed transmission resources. The method also includes mapping a first transmission resource to a first distributed transmission resource having a first index, and mapping a second transmission resource to a second distributed transmission resource having a second index, where the first index and the second index differ by a value equal to a difference in indices of distributed transmission resources in the pair of distributed transmission resources, and where the difference in indices is greater than or equal to two. The method further includes transmitting a first physical transmission resource associated with the first distributed transmission resource and a second physical transmission resource associated with the second distributed transmission resource.

In accordance with another example embodiment of the present invention, a method for communications controller operations is provided. The method includes generating two transmission resources from a first group of information to be transmitted on a first control channel, and assigning a first of the two transmission resources to a first distributed transmission resource, and a second of the two transmission resources to a second distributed transmission resource, where the first distributed transmission resource and the second distributed transmission resource are mapped to a single time slot of a physical transmission resource. The method also includes transmitting a first physical transmission resource associated with the first distributed transmission resource and a second physical transmission resource associated with the second distributed transmission resource.

In accordance with another example embodiment of the present invention, a communications controller is provided. The communications controller includes a generating unit, a mapping unit, and a transmitter. The generating unit generates a first control message from a first group of information, where the first control message occupies two transmission resources, and where a physical transmission resource comprises a pair of distributed transmission resources. The mapping unit maps a first transmission resource to a first distributed transmission resource having a first index, and maps a second transmission resource to a second distributed transmission resource having a second index, where the first index and the second index differ by a value equal to a difference in indices of distributed transmission resources in the pair of distributed transmission resources, and where the difference in indices is greater than or equal to two. The transmitter transmits a first physical transmission resource associated with the first distributed transmission resource and a second physical transmission resource associated with the second distributed transmission resource.

One advantage disclosed herein is that both slots of a physical resource block (PRB) pair are used. Therefore, the resources are more efficiently utilized and overall communications system efficiency is improved.

A further advantage of exemplary embodiments is that virtual resource blocks are selected to that when mapped to PRBs, sufficient separation is achieved in order to attain frequency diversity.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example communications system using RNs according to example embodiments described herein;

FIG. 2 illustrates an example frame structure for a downlink (DL) transmission from an eNB to a RN according to example embodiments described herein;

FIGS. 3a and 3b illustrate example resource block allocations for a virtual resource block pair according to example embodiments described herein;

FIG. 4a illustrates an example DVRB to PRB mapping for an R-PDCCH in the first slot and/or an R-PDCCH in the second slot with an aggregation level of two, wherein VRBs with an index difference of one are used according to example embodiments described herein;

FIG. 4b illustrates a second example DVRB to PRB mapping of R-PDCCH to a first slot and/or a second slot with an aggregation level of two, wherein VRBs with an index difference of one are used according to example embodiments described herein;

FIG. 5 illustrates an example DVRB to PRB mapping for an R-PDCCH with an aggregation level of two, wherein VRBs with an index difference of two are used according to example embodiments described herein;

FIG. 6a illustrates an example DVRB to PRB mapping for an R-PDCCH with an aggregation level of four, wherein four consecutive VRBs are used according to example embodiments described herein;

FIG. 6b illustrates an example DVRB to PRB mapping for an R-PDCCH with an aggregation level of eight, wherein eight consecutive VRBs are used according to example embodiments described herein;

FIG. 7 illustrates an example flow diagram of eNB operations in transmitting R-PDCCHs according to example embodiments described herein; and

FIG. 8 provides an example communications device according to example embodiments described herein.

### DETAILED DESCRIPTION OF ILLUSTRATIVE EMBODIMENTS

The making and using of the current example embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

One example embodiment of the invention relates to improving overall communications system performance by increasing resource utilization and/or providing frequency diversity. For example, mapping two transmission resources to two distributed transmission resources with an index difference equal to an index difference of two distributed transmission resources of a single physical transmission resource allows for greater utilization of resources of two physical transmission resources, thereby increasing resource utilization.

The present invention will be described with respect to example embodiments in a specific context, namely a 3GPP LTE compliant communications system with RNs. The invention may also be applied, however, to other standards compliant communications systems, such as those that are compliant with the IEEE 802.16, WiMAX, and so on, technical standards, as well as non-standards compliant communications systems that support RNs. The invention may also be applied to UEs although RNs are discussed as an example embodiment.

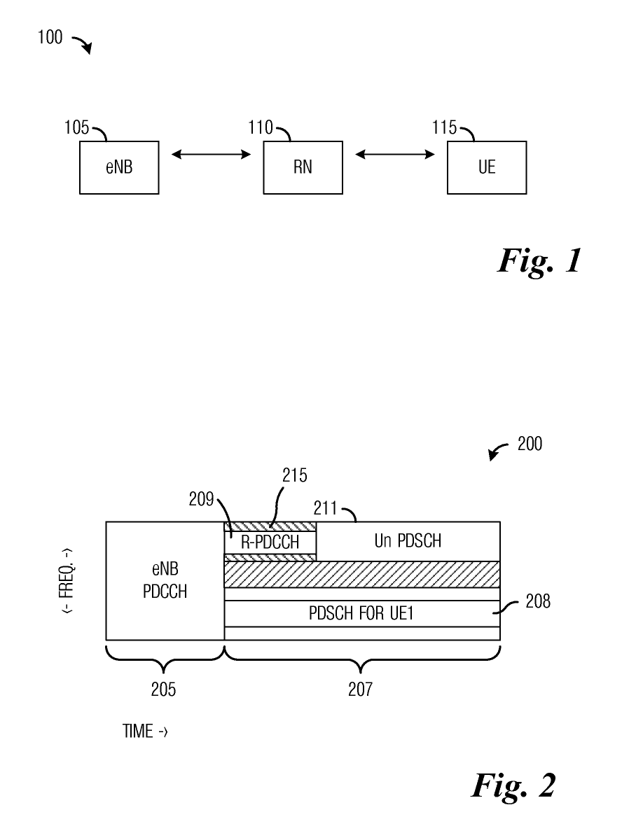

FIG. 1 illustrates a communications system 100 using RNs. Communications system 100 includes an eNB 105, a RN 110, and a UE 115. eNB 105 may control communications to UE, such as UE 115, as well as provide network resources to a RN, such as RN 110. As such, eNB 105 may be referred to as a D-eNB. eNB 105 may also be commonly referred to as a base station, communications controller, NodeB, enhanced NodeB, and so on, while UE 115 may be commonly referred to as a terminal, user, subscriber, mobile station, and so forth.

According to an example embodiment, RN 110 may receive transmissions from both eNB 105 and UE 115. RN 110 may then forward transmissions from UE 115 to eNB 105 and transmissions from eNB 105 to UE 115 (if they are so addressed).

While it is understood that communications systems may employ multiple eNBs capable of communicating with a number of UEs with or without RNs, only one eNB, one UE, and one RN are illustrated for simplicity.

FIG. 2 illustrates a frame structure for a downlink (DL) 200 transmission from an eNB to a RN. DL 200 includes a control region 205 and a data region 207. It is noted that in the frequency domain, the representation shown in FIG. 2 is logical, and does not necessarily represent the actual physical location in frequency of the various blocks. Although control region 205 is labeled as an eNB physical downlink control channel (PDCCH), control region 205 may contain other types of control channels or signals. Other types of control channels may include a Physical Control Format Indicator Channel (PCFICH), a Physical Hybrid Automatic Repeat Requested Indicator Channel (PHICH), and so forth, and other types of signals may include reference signals. Similarly, for simplicity data region 207 is shown with a physical downlink shared channel (PDSCH) 208. Since DL 200 is also a DL relay backhaul, DL 200 includes some resource elements dedicated for use as the DL relay backhaul, such as relay-physical downlink control channel (R-PDCCH) 209 and relay-physical downlink shared channel (R-PDSCH) 211, the R-PDSCH is also known as the Un PDSCH. Although data region 207 is shown containing several types of channels, it may contain other channels and/or signals as well. The other types of signals may include reference signals. Although the discussion focuses on RN specific control channels, such as the R-PDCCH, UE specific control channel such as U-PDCCH and UE specific PDSCH can also be transmitted in DL 200.

In DL 200, a RN does not know the exact location of its R-PDCCH. All it knows is that the R-PDCCH is located within a known set of resource blocks (RBs), commonly referred to as the R-PDCCH search space (an example of which is shown as search space 215). The R-PDCCH search space follows control region 205, occupying a set of subcarriers of one or several OFDM symbols in data region 207. Search space 215 may be specified by its frequency location. R-PDCCH 209 (if present) for the RN is located in the RN's search space 215. Search space 215 may be referred to as a virtual system bandwidth, which, in general, may be considered to be a set of resource blocks that can be semi-statically configured for potential R-PDCCH transmission. In other words, frequency domain parameters of the set of resource blocks may be semi-statically configured. Like a PDCCH in control region 205, R-PDCCH 209 provides information to support the transmission of DL and UL transport channel. R-PDCCH 209 may include information such as resource assignment, modulation and coding system (MCS) selection, Hybrid Automatic Repeat Request (HARM) information, and so on. That is, R-PDCCH 209 contains the information for detecting and decoding a Relay Physical Downlink Shared Channel (R-PDSCH), also known as the Un PDSCH, and/or the Relay Physical Uplink Shared Channel (R-PUSCH), also known as the Un PUSCH.

The R-PDCCH may be multiplexed with the data channels, such as a Physical Downlink Shared Channel (PDSCH), a R-PDSCH, and so forth, with time division multiplexing (TDM), frequency division multiplexing (FDM), or a combination thereof.

Although the discussion focuses on the R-PDCCH and the transmitting thereof, the example embodiments may be applied to other frequency domain extensions of the PDCCH, referred to generically as X-PDCCHs (or eXtended-PDCCH), and may include UE specific PDCCHs (U-PDCCH), enhanced PDCCHs (E-PDCCH or ePDCCH), secondary PDCCHs (S-PDCCH) and so forth. Therefore, the discussion of the R-PDCCH and the transmitting thereof should not be construed as being limiting to either the scope or the spirit of the example embodiments.

It may be beneficial to use distributed transmission for the R-PDCCH in order to ensure a high degree of robustness. In 3GPP LTE RAN1, there is wide agreement that a natural way of providing distributed transmission is to use distributed virtual resource blocks (DVRB), which is already defined in 3GPP LTE Release 8. In DVRB, virtual resource blocks (VRB) are allocated to physical resource blocks (PRB) that are separated in frequency so that the frequency fading on two consecutive DVRBs is generally uncorrelated or weakly correlated. In other words, the physical resource blocks are far apart enough in frequency or the physical resource blocks are sufficiently separated in frequency so that the frequency fading on two consecutive DVRBs is generally uncorrelated or weakly correlated.

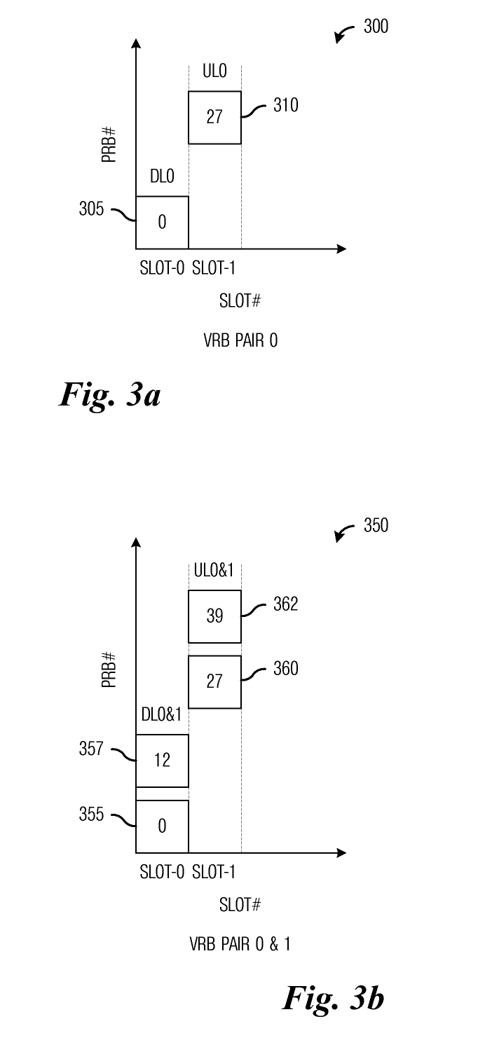

FIG. 3a illustrates a resource block allocation 300 for a virtual resource block pair. An allocation resource blocks shown in FIG. 3a follow the DVRB resource block allocation technique. The two VRBs in a VRB pair are generally mapped to PRBs that are about one-quarter to one-half of available PRBs away from each other in different slots.

By allocating the VRBs in the VRB pair to PRBs that are non-contiguous in frequency, frequency diversity may be achieved. As an example, in a single VRB pair #0, a first slot may be dedicated for use for control messages for the DL and a second slot may be dedicated for use for control messages for the UL. A first VRB of VRB pair #0 may be assigned to a first PRB, for example, PRB #0 305, and may be allocated as a VRB for control messages for the DL (a VRB of this type will be referred to as a DL-VRB hereinafter) and a second VRB of VRB pair #0 may be assigned to a second PRB, for example, PRB #27 310, and may be allocated as a VRB for control messages for the UL (a VRB of this type will be referred to as a UL-VRB hereinafter).

Since only one VRB pair is allocated and only a single PRB is allocated for each VRB of the VRB pair, frequency diversity may not be fully exploited on either the DL-VRB or the UL-VRB.

FIG. 3b illustrates a resource block allocation 350 for multiple resource block pairs. As shown in FIG. 3b, two VRB pairs (pair #0 and pair #1) are allocated to PRBs. A first PRB (PRB #0 355) in the first slot may be allocated as a DL-VRB of VRB pair #0 and a second PRB (PRB #12 357) in the first slot may be allocated as a DL-VRB of VRB pair #1, while a first PRB (PRB #27 360) of the second slot may be allocated to an UL-VRB of VRB pair #0 and a second PRB (PRB #39 362) of the second slot may be allocated to an UL-VRB of VRB pair #1. The DVRB pairs may be allocated using messaging similar to downlink control information (DCI) format 1A.

Since more than one VRB pair is allocated, multiple PRBs that are widely separated in frequency within each slot may be used, thereby allowing the exploitation of frequency diversity within each slot to improve communications system performance. The frequency diversity gain may not arise from the slot hopping of DVRB but from the distributed DVRB to PRB mapping occurring within each slot.

In general, the RN does not know an exact location of the R-PDCCH and blindly searches for the R-PDCCH within a first set of allocated resources, i.e., its search space. Usually, the first set of allocated resources is a set of contiguous VRBs. Typically, the search space is larger than a second set of allocated resources occupied by the R-PDCCH. According to the 3GPP LTE standards, the second set of resources (the R-PDCCH) may occupy one, two, four, or eight transmission resources, which may be RBs, slots, control channel elements (CCE), relay CCE (R-CCE), and so on. The number of transmission resources in the second set of resources, i.e., the number of transmission resources occupied by the R-PDCCH, may be referred to as an aggregation level of the R-PDCCH. Therefore, possible aggregation levels may include one, two, four, and eight. In general, the aggregation level is representative of an amount of bandwidth allocated, with higher aggregation levels corresponding to greater bandwidth allocations.

In addition to frequency diversity, another desirable feature of transmissions is to map RBs of the R-PDCCH to PRBs so that both slots of a PRB pair are fully occupied. Occupying both slots of the PRB pair helps to increase resource utilization, which improves overall communications system efficiency. As an example, if there are two VRB pairs to be transmitted, the two VRB pairs may be mapped to two PRBs in a first slot and two PRBs in a second slot. If there is only the second slot PRB of a PRB pair (also commonly referred to as an UL only grant) mapped by the R-PDCCH VRB, then due to the 3GPP LTE technical standards, it may be difficult to make use of the first slot of that PRB pair, which leads to resource waste. Therefore, the VRB allocation for R-PDCCH as described in the example embodiments herein, which enables both PRBs of the PRB pair to be used for R-PDCCH may increase utilization of the PRBs. It also makes multiplexing with other channels (such as, PDSCHs for the RN receiving the R-PDCCH, for other RNs, or some UEs directly served by the eNB) easier. In addition, it might be desirable to make sure to map RBs of the search space so that both slots of a PRB in the search space are fully occupied.

According to 3GPP LTE standards, if consecutive VRBs are assigned, then both slots of a PRB pair are naturally fully occupied for aggregation levels four and eight. However, full occupation of a PRB pair does not occur naturally for aggregation level two.

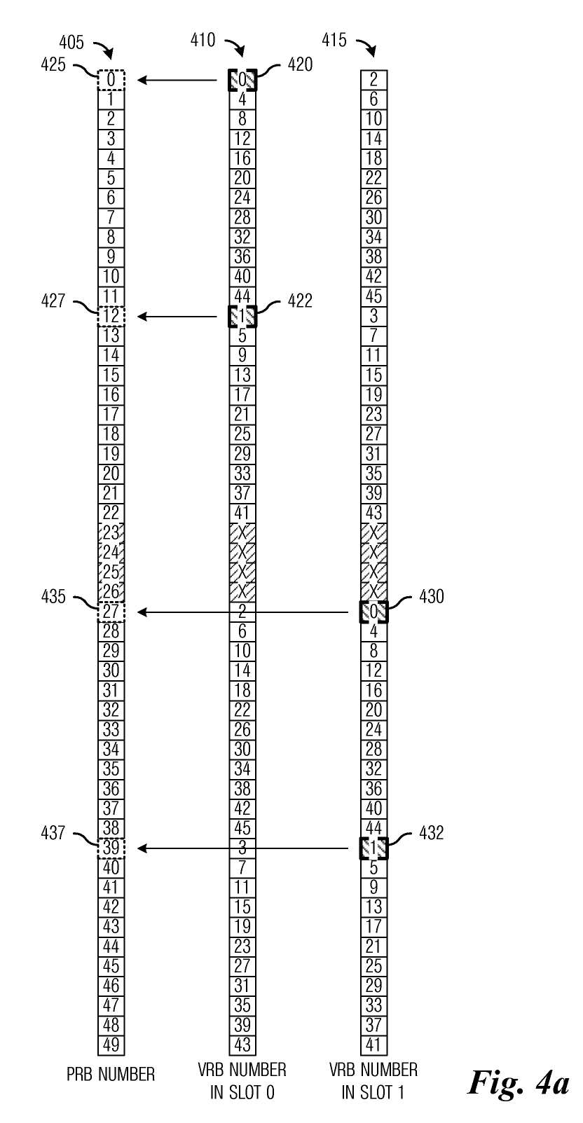

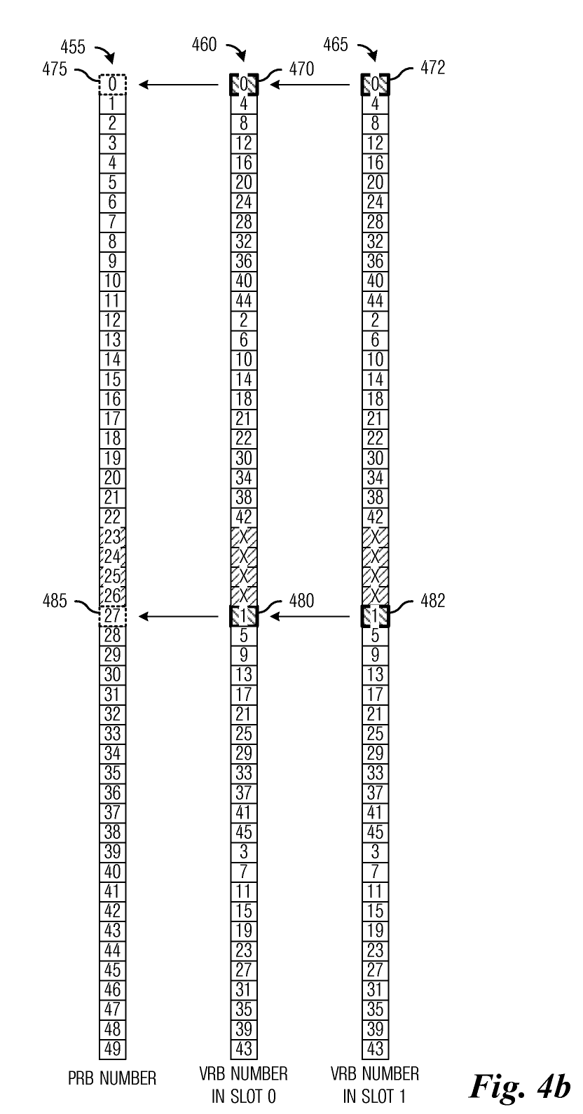

FIG. 4a illustrates an exemplary DVRB to PRB mapping for an R-PDCCH in the first slot and/or an R-PDCCH in the second slot with an aggregation level of two, wherein VRBs with an index difference of one are used. A first column of numbered boxes 405 represents PRBs ranging from PRB 0 to PRB 49, a second column of numbered boxes 410 represents VRBs mapped to a first slot (slot 0) of a PRB, and a third column of numbered boxes 415 represents VRBs mapped to a second slot (slot 1) of the PRB. As an illustrative example, VRB 0 is mapped to the first slot of PRB 0 and the second slot of PRB 27. Similarly, VRB 43 is mapped to the first slot of PRB 49 and the second slot of PRB 22. Therefore, in the first slot, PRB 49 is associated with VRB 43 and in the second slot PRB 22 is associated with VRB 43. It is noted that in FIG. 4a, logical VRB numbers are shown. In general, durations of the first slot and the second slot may be the same or they may be different.

A gap may be defined as a difference in PRB numbers for a pair of PRBs used to transmit the VRBs in the same aggregation level. As an example, consider VRB 0 420 and VRB 1 422. In the first slot, PRB 0 425 is used to transmit a first VRB (e.g., VRB 0 420) and in the first slot, PRB 12 427 is used to transmit a second VRB (e.g., VRB 1 422). Hence, the gap may be 12−0=12. Similarly, in the second slot, PRB 27 435 is used to transmit a third VRB (e.g., VRB 0 430) and in the second slot, PRB 39 437 is used to transmit a fourth VRB (e.g., VRB 1 432). The gap in the second slot is also 12.

FIG. 4b illustrates an exemplary DVRB to PRB mapping of R-PDCCHs to a first slot and/or a second slot with an aggregation level of two, wherein VRBs with an index difference of one are used. A first column of numbered boxes 455 represents PRBs ranging from PRB 0 to PRB 49, a second column of numbered boxes 460 represents VRBs mapped to a first slot (slot 0) of a PRB, and a third column of numbered boxes 465 represents VRBs mapped to a second slot (slot 1) of the PRB. As an illustrative example, VRB 0 is mapped to the first slot of PRB 0 and the second slot of PRB 0. Similarly, VRB 43 is mapped to the first slot of PRB 49 and the second slot of PRB 49. It is noted that in FIG. 4b, logical VRB numbers are shown.

In general, for DVRB transmission, a gap between PRBs used to transmit VRBs with an index difference of one should be at least one quarter to one half of system bandwidth apart in order to attain sufficient frequency diversity. An example of a sufficiently large gap is shown in FIG. 4b. Consider VRB 0 and VRB 1. In the first slot, PRB 0 475 is used to transmit a first part of VRB 0 470 and PRB 27 485 is used to transmit a first part of VRB 1 480. Therefore, the gap may be 27−0=27. Similarly, the gap value may be based on system bandwidth and/or signaling configuration. Table 1 illustrates gap values for a variety of system bandwidths and/or signaling configurations, as defined in the 3GPP LTE technical standards.

TABLE 1
Gap value for different system bandwidths.

Gap (N_{gap})

| System BW | 1^{st} Gap | 2^{nd} Gap |
|---|---|---|
| (N_{RB}^{DL}) | (N_{gap,1}) | (N_{gap,2}) |
| 6-10 | ┌N_{RB}^{DL}/2┐ | N/A |
| 11 | 4 | N/A |
| 12-19 | 8 | N/A |
| 20-26 | 12 | N/A |
| 27-44 | 18 | N/A |
| 45-49 | 27 | N/A |
| 50-63 | 27 | 9 |
| 64-79 | 32 | 16 |
| 80-110 | 48 | 16 |

The second slot may have same or a different VRB to PRB mapping method of the first slot. As shown in FIG. 4b, in the second slot, PRB 0 475 is used to transmit a second part of VRB 0 472 and PRB 27 is used to transmit a second part of VRB 1 482. Hence, the gap may be 27−0=27

As shown in FIG. 4b, it may be possible to denote a VRB transmitted in a PRB associated with an aggregation level two control channel as VRB 4k, VRB 4k+1, VRB 4k+2, or VRB 4k+3, where k is an integer value. Then, when two VRBs with the same aggregation level are denotable as VRB 4k and VRB 4k+1, then a PRB that includes VRB 4k+1 follows a PRB that includes VRB 4k and the two PRBs are separated by a gap as specified by the 3GPP LTE technical standards and is based on system bandwidth and/or signaling configuration, such as shown in Table 1. If two VRBs with the same aggregation level are denotable as VRB 4k+2 and VRB 4k+3, then a PRB that includes VRB 4k+2 follows a PRB that includes VRB 4k+3 and the two PRBs are separated by a gap as specified by the 3GPP LTE technical standards and is based on system bandwidth and/or signaling configuration, such as shown in Table 1.

According to 3GPP LTE technical standards, for the aggregation level of two, the transmission of an R-PDCCH (either an R-PDCCH DL grant only, an R-PDCCH UL grant only, or both) may be performed using two VRBs (for each slot) with an index difference of one, e.g., VRBs 0 and 1, VRBs 1 and 2, VRBs 2 and 3, VRBs N−2 and N−1, and so on, where N is a number of VRBs. However, it is generally accepted that if the R-PDCCH comprises only a single grant (e.g., either a DL grant or an UL grant), then one of the two slots will remain unoccupied. As an illustrative example, consider that the R-PDCCH is be transmitted on VRBs 0 and 1. As shown in FIG. 4b, in the first slot VRB 0 470 corresponds to PRB 0 475 and VRB 1 480 corresponds to PRB 27 485. While in the second slot VRB 0 472 corresponds to PRB 0 472 and VRB 1 482 corresponds to PRB 27 485.

Therefore, if there is only a DL grant or an UL grant, then only one of the two slots of PRB 0 475 and PRB 27 485 is occupied. Hence, half of the transmission resources are unoccupied and wasted. Although it is possible that the unoccupied transmission resources are allocated to other transmissions, e.g., using the distributed version of transmission mode 2 for another channel, such as a PDSCH, the use of the unoccupied transmission resources may be dependant on the availability of another transmission using the unoccupied transmission resources. Furthermore, additionally scheduling and/or coordination may be needed to allocate the other transmission to the unoccupied transmission resources, which may increase communications system overhead. As discussed previously, if there is only the second slot PRB of a PRB pair (also commonly referred to as an UL only grant) mapped by the R-PDCCH VRB, then due to the 3GPP LTE technical standards, it may be difficult to make use of the first slot of that PRB pair, which leads to resource waste.

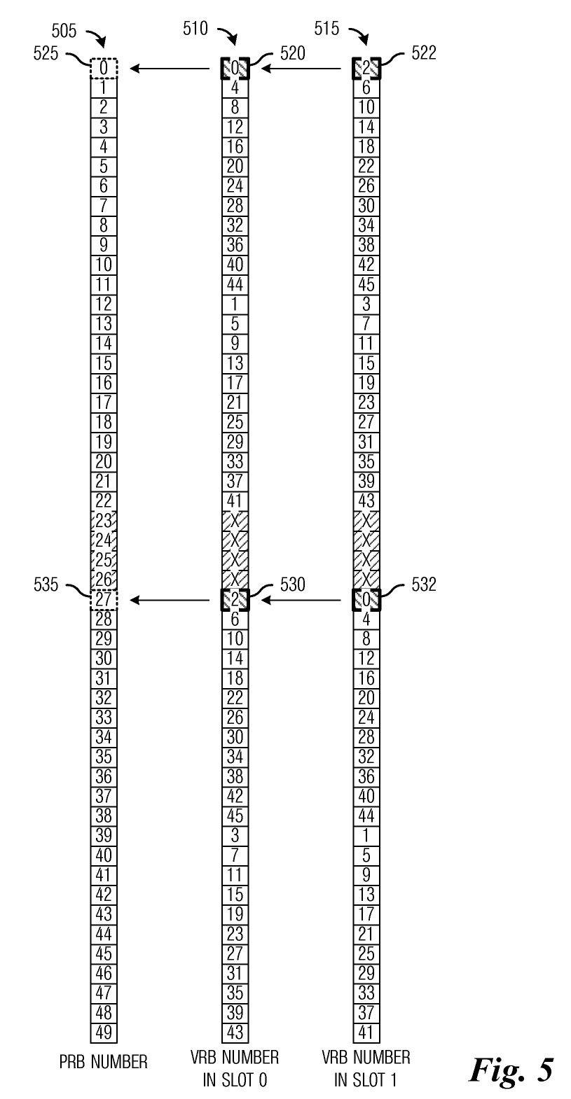

FIG. 5 illustrates an exemplary DVRB to PRB mapping for an R-PDCCH with an aggregation level of two, wherein VRBs with an index difference of two are used. A first column of numbered boxes 505 represents PRBs ranging from PRB 0 to PRB 49, a second column of numbered boxes 510 represents VRBs mapped to a first slot (slot 0) of a PRB, and a third column of numbered boxes 515 represents VRBs mapped to a second slot (slot 1) of the PRB.

Although the discussion focuses on VRBs with indices that are different by a value of two, in general, the example embodiments discussed herein are operable with indices that are different by a value equal to the difference in indices of the VRBs mapped to the first slot and to the second slot of a single PRB. Therefore, the discussion of the difference being equal to two should not be construed as being limiting to either the scope or the spirit of the example embodiments. More generally, the difference in indices between two VRB of a single PRB should be such that the two VRBs are “paired” together. In other words, a PRB occupied by the first VRB transmitted in the first slot is the same as a PRB occupied by the second VRB transmitted in the second slot, and the PRB occupied by the first VRB in the second slot is the same as the PRB occupied by the second VRB in the first slot.

According to an example embodiment, for the aggregation level of two, the transmission of an R-PDCCH may be performed using two VRBs with an index difference of two, e.g., VRBs 0 and 2, VRBs 1 and 3, VRBs 2 and 4, VRBs N−3 and N−1, and so on, where N is a number of VRBs. As an illustrative example, consider that the R-PDCCH be transmitted on VRBs 0 and 2. As shown in FIG. 5, in the first slot VRB 0 520 corresponds to PRB 0 525 and VRB 2 530 corresponds to PRB 27 535. While in the second slot VRB 0 corresponds to PRB 27 535 and VRB 2 corresponds to PRB 0 525. The gap value within a single slot is 27−0=27.

Therefore, PRB 0 525 and PRB 27 535 have both of their VRB slots occupied. Hence, neither of the VRB slots of PRB 0 525 and PRB 27 535 are unoccupied and wasted. Additionally, the full occupation of the VRB slots does not require an additional transmission.

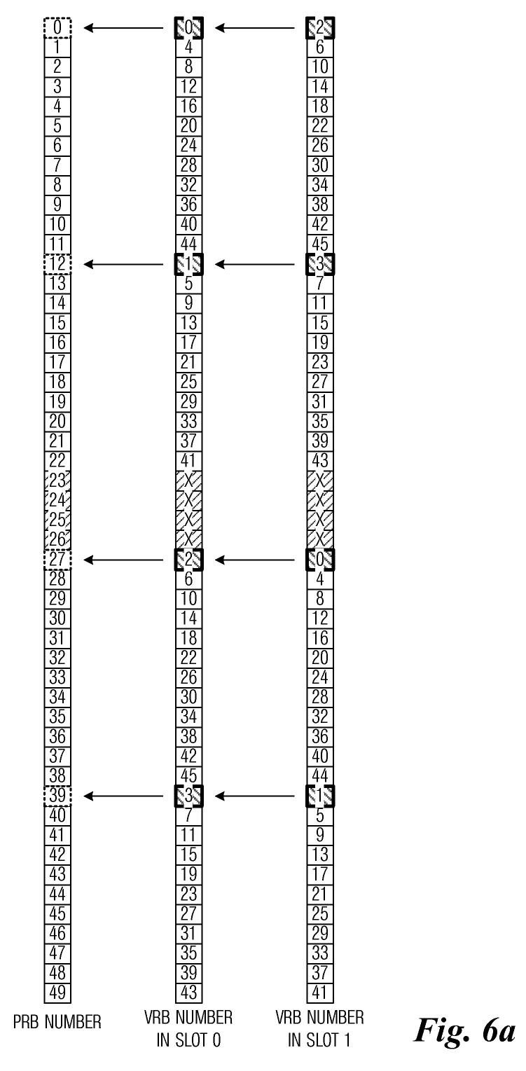

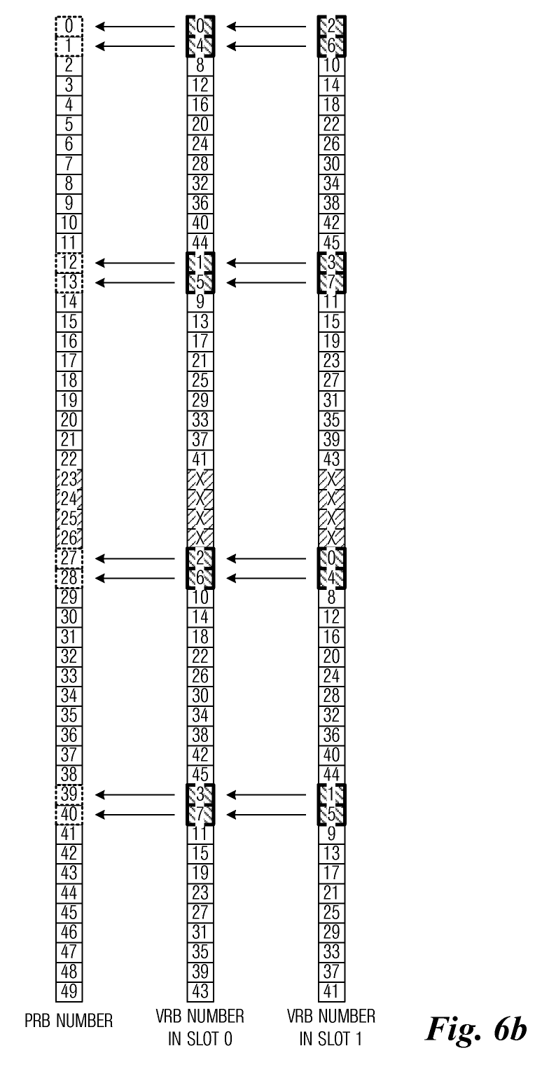

FIG. 6a illustrates an exemplary DVRB to PRB mapping for an R-PDCCH with an aggregation level of four, wherein four consecutive VRBs are used. As shown in FIG. 6a, VRBs 0, 1, 2, and 3 are used in the transmission of the R-PDCCH. In addition to illustrating the exemplary DVRB to PRB mapping for the R-PDCCH with an aggregation level of four, FIG. 6a also illustrates optimized frequency packing occupancy for two R-PDCCHs each with an aggregation level of two.

FIG. 6b illustrates an exemplary DVRB to PRB mapping for an R-PDCCH with an aggregation level of eight, wherein eight consecutive VRBs are used. As shown in FIG. 6b, VRBs 0, 1, 2, 3, 4, 5, 6, and 7 are used in the transmission of the R-PDCCH.

In general, assuming that the search space for the R-PDCCH comprises N VRBs, the rules for VRB selection for R-PDCCHs of different aggregation levels are as follows.

Aggregation Level One—The R-PDCCH transmission may be on one of the N VRBs;

Aggregation Level Two—The R-PDCCH transmission may be on two of the N VRBs with a requirement that indices of the two VRBs differ by two;

Aggregation Level Four—The R-PDCCH transmission may be on any four consecutively numbered VRBs; and

Aggregation Level Eight—The R-PDCCH transmission may be on any eight consecutively numbered VRBs.

According to an example embodiment, if the first set of resources is not consecutive in the logical domain, then the resources may be bundled together and treated as if they were contiguous.

According to an example embodiment, while described for VRBs, the example embodiments also apply to localized RB allocation. The use of localized RB allocation may help to ease implementation by having a single mapping for both distributed and localized transmission. The example embodiments may apply to PRBs as well as VRBs.

According to an example embodiment, to simplify implementation, for R-PDCCHs with an aggregation level of four, an exemplary order for transmitting the DVRB may be k, k+2, k+1, and k+3; or k, k+1, k+2, and k+3; or any other possible ordering of the four DVRBs. A similar ordering of DVRBs may also be used for transmitting R-PDCCHs with an aggregation level of eight.

According to an example embodiment, for R-PDCCHs with an aggregation level of two, the transmission may occur as described above or on two consecutive PRBs on VRBs k and k+2; or k and k+1. While potentially less spectrally efficient, the latter option may capture more frequency diversity and the paired VRB may be allocated to the PDSCH, as an example. A choice of either of the two options may be signaled. Alternatively, the RN may blindly detect for both possibilities.

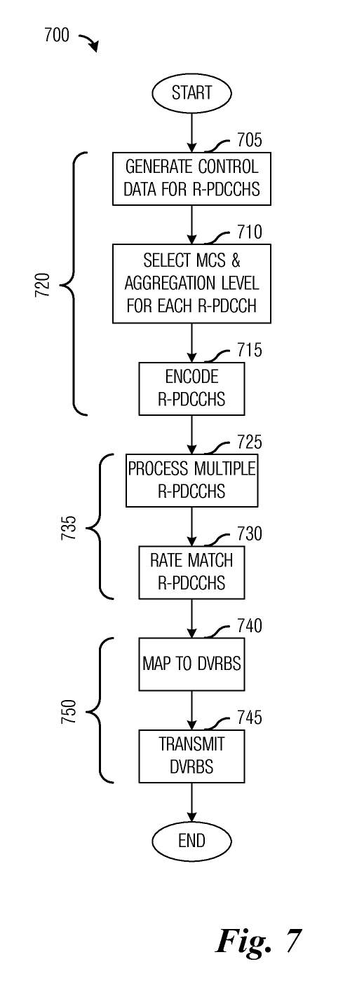

FIG. 7 illustrates a flow diagram of eNB operations 700 in transmitting R-PDCCHs. eNB operations 700 may be indicative of operations occurring in a communications controller, such as eNB 105, as the eNB transmits R-PDCCHs to RN(s) coupled to the eNB. eNB operations 700 may occur while the eNB is in a normal operating mode and has RN(s) coupled to it.

eNB operations 700 may begin with the eNB generating control data for each RN coupled to the eNB (block 705). In general, there is a separate R-PDCCH for each RN coupled to the eNB. According to an example embodiment, the control data may include resource assignment, modulation and coding scheme (MCS), Hybrid Automatic Repeat Request (HARM) information, and so on.

The eNB may select a MCS and aggregation level for each R-PDCCH (block 710). The eNB may select a MCS for each R-PDCCH in accordance with a set of selection criteria. Possible modulation may include QPSK, 16-QAM, 64-QAM, or any other modulation. The coding rate selected may be chosen, depending which modulation is used, so that the RN may receive its R-PDCCH with a reasonable probability of successful decoding. The aggregation level, which specifies allocated bandwidth for the R-PDCCH, may also impact MCS. In addition, the eNB may select to use spatial multiplexing.

The MCS and the aggregation level selected for the RNs may be different or be identical or a combination thereof. Examples of the set of selection criteria may include amount of control data to be transmitted, amount of network resources available per R-PDCCH, operating environment, communications system load, a quality of the communications channel between the eNB and the RNs, and so forth.

With the MCS and the aggregation level selected for each RN, the eNB may encode each R-PDCCH in accordance with its selected MCS and selected aggregation level (block 715). However, the encoding may also be performed in accordance to other factors, including permissible codes, rates, and so forth. Collectively, generating control data (block 705), MCS and aggregation level selection (block 710), and R-PDCCH encoding (block 715) may be collectively referred to as preparing the R-PDCCH 720.

If there are multiple encoded R-PDCCHs, the eNB may process the multiple R-PDCCHs (block 725). The eNB may either multiplex the encoded R-PDCCHs together with cross interleaved R-PDCCHs or not multiplex the encoded R-PDCCHs without cross interleaving the R-PDCCHs. As an example, the eNB may multiplex the encoded control data from the individual R-PDCCHs into a single R-PDCCH. The multiplexing of the encoded control data may be performed using any of a variety of multiplexing techniques.

The eNB may also perform rate-matching for the R-PDCCH on an individual basis (block 730). Rate-matching may help to increase network resource utilization so that there is little or no network resource waste. Rate-matching helps to ensure that all resource elements (RE) of a resource block (RB) are occupied by matching a rate of the R-PDCCH with the rate of the resource elements of the resource blocks, thereby reducing or eliminating resource waste. Rate-matching may be optional. Collectively, processing multiple R-PDCCHs (block 725) and rate-matching R-PDCCHs (block 730) may be referred to as generating the R-PDCCH 535.

The R-PDCCH, the R-PDCCHs, or the multiplexed R-PDCCH, which may also be rate-matched, may then be mapped or assigned to VRBs based on a distributed virtual resource mapping rule to help utilize frequency diversity and to increase resource utilization (block 740). According to an example embodiment, the mapping or assigning of the R-PDCCH (or the R-PDCCHs or the multiplexed R-PDCCH) may be mapped to VRBs and PRBs based on the aggregation level of the R-PDCCH (or the R-PDCCHs or the multiplexed R-PDCCH).

As an example, if the aggregation level of the R-PDCCH is one, then the R-PDCCH may be mapped to any one of the VRBs, while if the aggregation level of the R-PDCCH is two, then the R-PDCCH may be mapped to any two VRBs with a restriction that indices of the two VRBs differ by two. Similarly, if the aggregation level of the R-PDCCH is four, then the R-PDCCH may be mapped to any four consecutive VRBs, and if the aggregation level of the R-PDCCH is eight, then the R-PDCCH may be mapped to any eight consecutive VRBs.

According to an example embodiment, the mapping of the R-PDCCH (or the R-PDCCHs or the multiplexed R-PDCCH) to VRBs may be configured so that the VRB slot pair of a single PRB are filled. For example, referencing FIG. 5, PRB 2 has VRB 8 and VRB 10 in its two time slots. Therefore, to ensure that both VRBs of the VRB slot pair are utilized, the R-PDCCH (with aggregation level two) may be mapped to VRB 8 and VRB 10. Similarly, PRB 20 has VRB 33 and VRB 35 in its two time slots. The R-PDCCH may be mapped to VRB 33 and VRB 35 respectively to ensure full utilization of the PRB.

According to the example embodiment, a gap value between the two PRBs mapped from the adjacent VRBs is 27 for many adjacent VRBs, e.g., VRBs 0 and 2; VRBs 1 and 3; VRB 4 and 6; VRB 5 and 7; and so on. Thus enough frequency diversity gain is achieved for the R-PDCCH in each slot.

The VRBs may then be mapped to PRBs and then transmitted (block 745). Collectively, mapping to DVRBs (block 740) and transmitting DVRBs (block 745) may be referred to as transmitting the R-PDCCH 750.

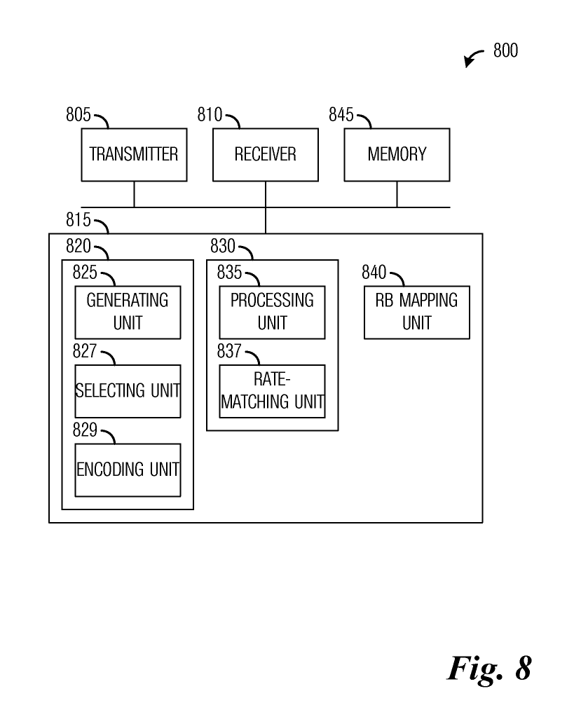

FIG. 8 provides an illustration of a communications device 800. Communications device 800 may be an implementation of an eNB of a communications system. Communications device 800 may be used to implement various ones of the embodiments discussed herein. As shown in FIG. 8, a transmitter 805 is configured to send control channels, messages, information, and so forth, and a receiver 810 is configured to receive messages, information, and so on. Transmitter 805 and receiver 810 may have a wireless interface, a wireline interface, or a combination thereof.

A control channel preparing unit 820 is configured to generate control data for RNs coupled to communications device 800, select MCS and aggregation level for R-PDCCHs, and encode the R-PDCCHs. A generating unit 825 is configured to generate control data for the RNs, including resource assignment, MCS, HARQ information, and so on. A selecting unit 827 is configured to select MCS and aggregation level for the R-PDCCHs. An encoding unit 829 is configured to encode the control data in accordance with the MCS and the aggregation level for the R-PDCCHs.

A control channel generating unit 830 is configured to combine, e.g., multiplex, the R-PDCCHs together if there are multiple R-PDCCHs, and to individually rate-match the R-PDCCHs. A processing unit 835 is configured to combine or not combine the multiple R-PDCCHs. A rate-matching unit 837 is configured to rate-match the R-PDCCHs.

A resource block mapping unit 840 is configured to map the R-PDCCH or the combined R-PDCCH to VRBs based on a distributed virtual resource mapping rule to help utilize frequency diversity and to increase resource utilization.

A memory 845 is configured to control data, R-PDCCH MCS, R-PDCCH aggregation levels, VRB assignments, distributed virtual resource mapping rules, and so forth.

The elements of communications device 800 may be implemented as specific hardware logic blocks. In an alternative, the elements of communications device 800 may be implemented as software executing in a processor, controller, application specific integrated circuit, or so on. In yet another alternative, the elements of communications device 800 may be implemented as a combination of software and/or hardware.

As an example, transmitter 805 and receiver 810 may be implemented as a specific hardware block, while control channel preparing unit 820 (generating unit 825, selecting unit 827, and encoding unit 829), control channel generating unit 830 (processing unit 835, and rate-matching unit 837), and resource block mapping unit 840 may be software modules executing in a processor 815, a microprocessor, a digital signal processor, a custom circuit, or a custom compiled logic array of a field programmable logic array.

The above described embodiments of communications device 800 may also be illustrated in terms of methods comprising functional steps and/or non-functional acts. The previous description and related flow diagrams illustrate steps and/or acts that may be performed in practicing example embodiments of the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the description of the flow diagrams(s) for FIG. 7—is used to indicate the desired specific use (or non-use) of such terms.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for communications controller operations, the method comprising:
generating a first control message from a first group of information, wherein the first control message occupies two transmission resources, and wherein a physical transmission resource comprises a pair of distributed transmission resources;
mapping a first transmission resource to a first distributed transmission resource having a first index;
mapping a second transmission resource to a second distributed transmission resource having a second index, wherein the first index and the second index differ by a value equal to a difference in indices of distributed transmission resources in the pair of distributed transmission resources, and wherein the difference in indices is greater than or equal to two; and
transmitting a first physical transmission resource associated with the first distributed transmission resource and a second physical transmission resource associated with the second distributed transmission resource.

2. The method of claim 1, wherein the first control message has an aggregation level of two.

3. The method of claim 1, wherein there is a total of N distributed transmission resources, and wherein the first index is equal to K, and the second index is equal to K+2, where K ranges from zero to N−3.

4. The method of claim 1, wherein a communications controller is a Third Generation Partnership Project Long Term Evolution compliant communications controller.

5. The method of claim 1, wherein the generating the first control message comprises:
selecting a modulation and coding scheme for the first control message; and
encoding the first group of information based on the selected modulation and coding scheme.

6. The method of claim 5, wherein there are multiple control messages, and wherein the generating the first control message further comprises:
combining the multiple control messages; and
rate matching the combined multiple control messages.

7. The method of claim 1, wherein the transmitting comprises transmitting the first physical transmission resource and the second physical transmission resource in a time slot.

8. The method of claim 1, wherein a transmission resource comprises a resource block, a physical resource block pair, a control channel element, or a relay control channel element.

9. The method of claim 1, wherein a distributed transmission resource comprises a Third Generation Partnership Project Long Term Evolution distributed virtual resource block.

10. The method of claim 1, wherein a distributed transmission resource comprises a Third Generation Partnership Project Long Term Evolution localized virtual resource block.

11. The method of claim 1, wherein the first control message is to be transmitted over a control channel, and wherein the control channel comprises a relay physical downlink control channel or a frequency domain extension of a physical downlink control channel.

12. The method of claim 11, wherein the frequency domain extension of the physical downlink control channel comprises one or more of a User Equipment specific physical downlink control channel, an enhanced physical downlink control channel, or a secondary physical downlink control channel.

13. The method of claim 1, wherein the first control message comprises a portion of a control channel.

14. The method of claim 1, wherein the transmitting the first physical transmission resource associated with the first distributed transmission resource and the second physical transmission resource associated with the second distributed transmission resource occurs in a first time slot, wherein the method further comprises:
generating a second control message from a second group of information, wherein the second control message occupies two transmission resources;
mapping a third transmission resource to a third distributed transmission resource having the second index;
mapping a fourth transmission resource to a fourth distributed transmission resource having the first index; and
transmitting a third physical transmission resource associated with the third distributed transmission resource and a fourth physical transmission resource associated with the fourth distributed transmission resource in a second time slot.

15. A method for communications controller operations, the method comprising:
generating two transmission resources from a first group of information to be transmitted on a first control channel;
assigning a first of the two transmission resources to a first distributed transmission resource, and a second of the two transmission resources to a second distributed transmission resource, wherein the first distributed transmission resource and the second distributed transmission resource are mapped to a single time slot of a physical transmission resource; and
transmitting a first physical transmission resource associated with the first distributed transmission resource and a second physical transmission resource associated with the second distributed transmission resource.

16. The method of claim 15, wherein the first physical transmission resource and the second physical transmission resource are transmitted in a single time slot.

17. The method of claim 15, wherein the generating two transmission resources comprises encoding the first group of information based on a selected modulation and coding scheme.

18. The method of claim 15, further comprising:
generating two additional transmission resources from a second group of information to be transmitted on a second control channel;
assigning a first of the two additional transmission resources to a third distributed transmission resource, and a second of the two additional transmission resources to a fourth distributed transmission resource, wherein the third distributed transmission resource and the fourth distributed transmission resource are mapped to a single time slot of a physical transmission resource; and
transmitting a third physical transmission resource associated with the third distributed transmission resource and a fourth physical transmission resource associated with the fourth distributed transmission resource.

19. The method of claim 18, wherein the first distributed transmission resource and the second distributed transmission resource are transmitted in a first time slot and the third distributed transmission resource and the fourth distributed transmission resource are transmitted in a second time slot, and wherein the first time slot differs from the second time slot.

20. The method of claim 19, wherein the first time slot and the second time slot differ in duration.

21. The method of claim 15, wherein the control channel has an aggregation level of two.

22. The method of claim 15, wherein the first transmission resource and the second transmission resource are assigned in sequence to the first distributed transmission resource and to the second distributed transmission resource.

23. The method of claim 22, wherein the first transmission resource and the second transmission resource are assigned in increasing order or in decreasing order in a frequency domain.

24. The method of claim 15, wherein the first distributed transmission resource has an associated first index and the second distributed transmission resource has an associated second index, and wherein the first index and the second index correspond to indices of a pair of distributed transmission resources of a physical transmission resource.

25. The method of claim 15, wherein a gap specifies a number of physical transmission resources in between a third physical transmission resource associated with the first distributed transmission resource in a first slot and a fourth physical transmission resource associated with the second distributed transmission resource in the first slot, and wherein the gap depends on a bandwidth of a communications system, a signaling configuration of the communications system, or a combination thereof.

26. The method of claim 15, wherein the first physical transmission resource and the second physical transmission resource are transmitted in a single time slot, wherein the first physical transmission resource and the second physical transmission resource are referred to as resource 4k and resource 4k+1, respectively, where k is an integer value, and wherein when the resource 4k and the resource 4k+1 are transmitted in single time slot, where the resource 4k+1 follows the resource 4k with a gap value based on a bandwidth of a communications system, a signaling configuration of the communications system, or a combination thereof.

27. The method of claim 15, wherein the first physical transmission resource and the second physical transmission resource are transmitted in a single time slot, wherein the first physical transmission resource and the second physical transmission resource are referred to as resource 4k+2 and resource 4k+3, respectively, where k is an integer value, and wherein when the resource 4k+2 and the resource 4k+3 are transmitted a single time slot, where the resource 4k+2 follows the resource 4k+3 with a gap value based on a bandwidth of a communications system, a signaling configuration of the communications system, or a combination thereof.

28. A communications controller comprising:
a generating unit configured to generate a first control message from a first group of information, wherein the first control message occupies two transmission resources, and wherein a physical transmission resource comprises a pair of distributed transmission resources;
a mapping unit configured to map a first transmission resource to a first distributed transmission resource having a first index, and to map a second transmission resource to a second distributed transmission resource having a second index, wherein the first index and the second index differ by a value equal to a difference in indices of distributed transmission resources in the pair of distributed transmission resources, and wherein the difference in indices is greater than or equal to two; and
a transmitter configured to transmit a first physical transmission resource associated with the first distributed transmission resource and a second physical transmission resource associated with the second distributed transmission resource.

29. The communications controller of claim 28, wherein the first control message has an aggregation level of two.

30. The communications controller of claim 28, wherein there is a total of N distributed transmission resources, and wherein the first index is equal to K, and the second index is equal to K+2, where K ranges from zero to N−3.

31. The communications controller of claim 28, wherein the generating unit comprises:
a selecting unit configured to select a modulation and coding scheme for the first control message; and
an encoding unit configured to encode the first group of information based on the selected modulation and coding scheme.

32. The communications controller of claim 28, wherein the first control message is transmitted on a relay physical downlink control channel or a frequency domain extension of a physical downlink control channel.

33. The communications controller of claim 28, wherein the communications controller is a Third Generation Partnership Project Long Term Evolution compliant communications controller.

34. The communications controller of claim 28, wherein the generating unit is further configured to generate a second control message from a second group of information, wherein the second control message occupies two transmission resources, wherein the mapping unit is further configured to map a third transmission resource to a third distributed transmission resource having a second index and to map a fourth transmission resource to a fourth distributed transmission resource having the first index, wherein the transmitter is configured to transmit the first physical transmission resource and the second physical transmission resource in a first time slot, and wherein the transmitter is further configured to transmit a third physical transmission resource associated with the third distributed transmission resource and a fourth physical transmission resource associated with the fourth distributed transmission resource in a second time slot.
